(19) United States
(12) Patent Application Publication
(10) Pub. No.: US 2017/0121488 A1
(43) Pub. Date: May 4, 2017

(54) METAL NANOPARTICLE SULFONATED POLYESTER COMPOSITES AND METHODS OF MAKING THE SAME

(71) Applicant: XEROX CORPORATION, Norwalk, CT (US)

(72) Inventors: VALERIE M. FARRUGIA, Oakville (CA); ALANA DESOUZA, London (CA); SANDRA J. GARDNER, Oakville (CA)

(21) Appl. No.: 15/407,707

(22) Filed: Jan. 17, 2017

Related U.S. Application Data
(63) Continuation of application No. 14/531,900, filed on Nov. 3, 2014.

(51) Int. Cl. C08K 3/08; C08J 9/00

(52) U.S. Cl. CPC C08K 3/08; C08J 9/0066; C08K 2003/0806; C08J 2367/02

(57) ABSTRACT

A composite includes a sulfonated polyester matrix and a plurality of silver nanoparticles dispersed within the matrix. Methods to make these composites include heating a sulfonated polyester resin in an organic-free solvent adding a solution of silver (I) ion to the heated resin in water to form a mixture, adding a solution of a reducing agent to the mixture, thereby forming an emulsion of composite particles including a sulfonated polyester matrix and a plurality of silver nanoparticles disposed within the sulfonated polyester matrix. Various articles can be manufactured from such composites.

### CROSS-REFERENCE TO RELATED APPLICATIONS

This application is a continuation of U.S. application Ser. No. 14/531,900, filed Nov. 3, 2014.

### BACKGROUND

The present disclosure relates to composites. In particular, the present disclosure relates to composites comprising metal nanoparticles dispersed throughout the composite matrix.

There is an increasing interest in mixed inorganic/organic composite systems due to the property benefits each of the individual constituents confers on the composite material. One particular area of interest is silver nanoparticle (AgNP)-laden polymer composites. Such composites may be useful in antimicrobial applications, biosensor materials, composite fibers, cryogenic superconducting materials, cosmetic products, and electronic components. The unique properties of AgNPs, including size and shape-dependent optical, electrical, and magnetic properties, has resulted in increasing usage in consumer and medical products.

Many methods for the manufacture of metal/polymer nanostructured materials require pre-fabrication of metal nanoparticles by reduction of a metal salt precursor prior to incorporation into polymer matrices. For example, conventional methods for making silver/polymer nanostructured materials, in particular, generally require melt mixing or extrusion of silver nanoparticles (AgNPs) in polymer matrices. Unfortunately, these methods often suffer from silver nanoparticle aggregation.

### SUMMARY

In some aspects, embodiments herein relate to composites comprising a sulfonated polyester matrix and a plurality of silver nanoparticles dispersed within the matrix.

In some aspects, embodiments herein relate to method comprising heating a sulfonated polyester resin in an organic-free solvent adding a solution of silver (I) ion to the heated resin in water to form a mixture, adding a solution of a reducing agent to the mixture, thereby forming an emulsion of composite particles comprising a sulfonated polyester matrix and a plurality of silver nanoparticles disposed within the sulfonated polyester matrix.

In some aspects, embodiments herein relate to articles comprising a composite comprising a sulfonated polyester matrix and a plurality of silver nanoparticles dispersed within the matrix.

### BRIEF DESCRIPTION OF DRAWINGS

Various embodiments of the present disclosure will be described herein below with reference to the figures wherein:

FIG. 1 shows a schematic of a possible mechanism of sodio sulfonated polyester self-assembly in the presence of Ag.

FIG. 2A (left) shows a scanning electron micrograph (SEM) image of Sample 1, a branched sulfonated polyester (BSPE)-silver nanoparticle (AgNP) composite prepared via silver salt reduction with trisodium citrate. Silver nanoparticles appear as white specks in SEM images.

FIG. 2B (right) shows a transmission electron microscope (TEM) image of Sample 1, as in FIG. 2A. Silver nanoparticles appear as black specks in TEM images.

FIG. 3A shows a SEM image of Sample 2, another BSPE-AgNP composite prepared via silver salt reduction with trisodium citrate.

FIG. 3B shows a SEM image of BSPE matrix alone (control) with no AgNPs present.

FIG. 4A (left) shows a SEM image of Sample 4, a BSPE-AgNP composite prepared via silver salt reduction with L-ascorbic acid.

FIG. 4B shows a TEM (right) image of Sample 4, as in FIG. 4A.

FIG. 5 shows overlaid absorbance spectra of low, medium and high loadings of silver nanoparticles in BSPE matrix composite Samples 6, 5, and 7, respectively.

### DETAILED DESCRIPTION

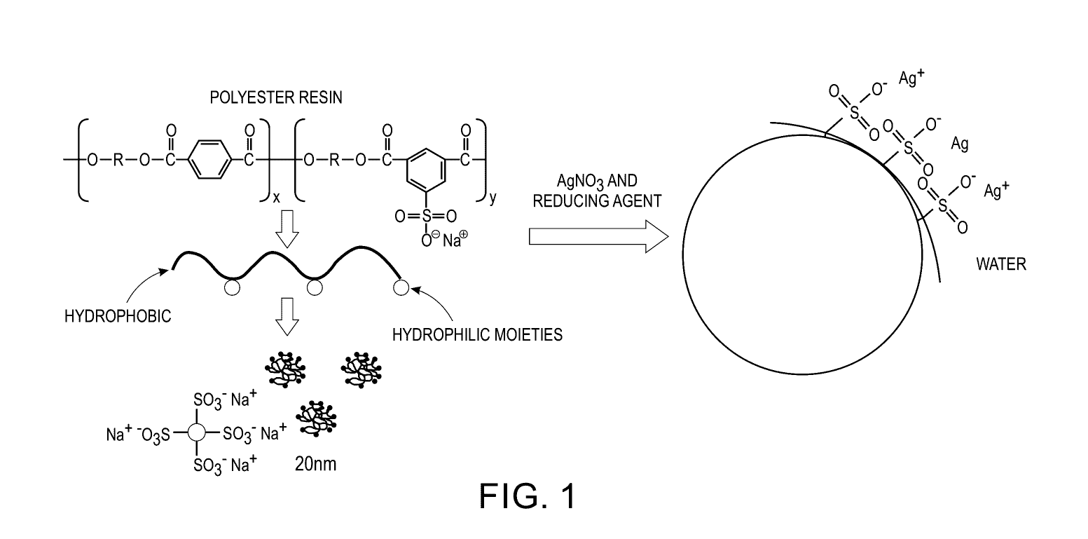

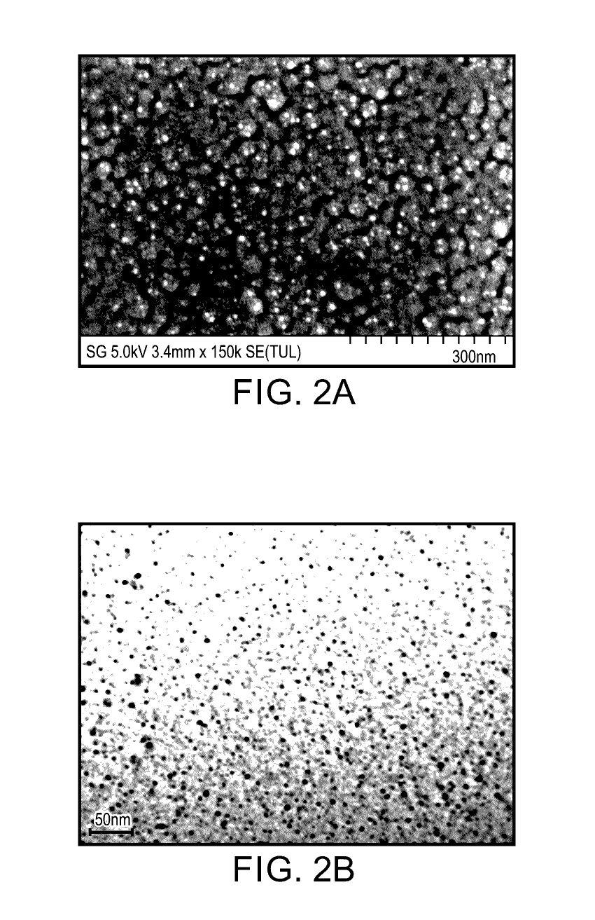

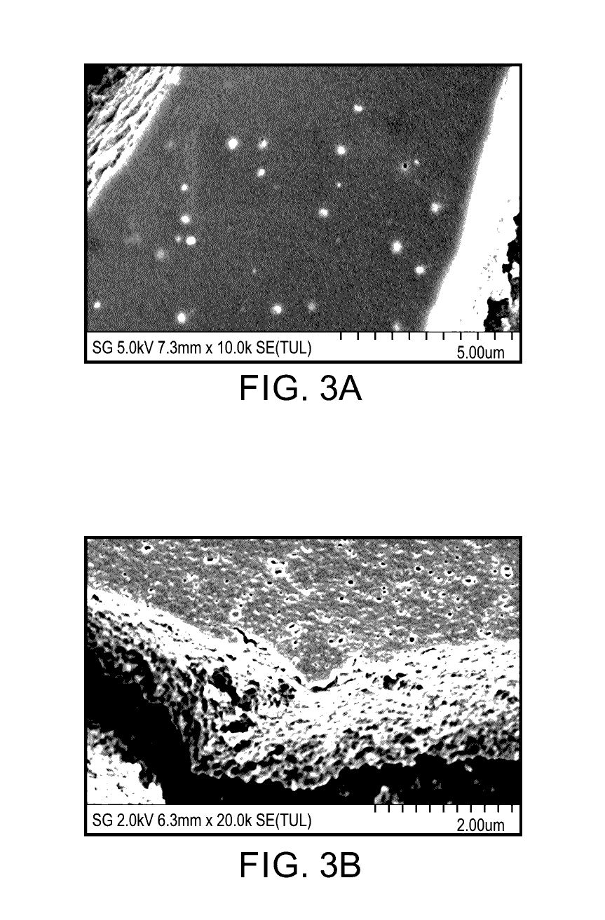

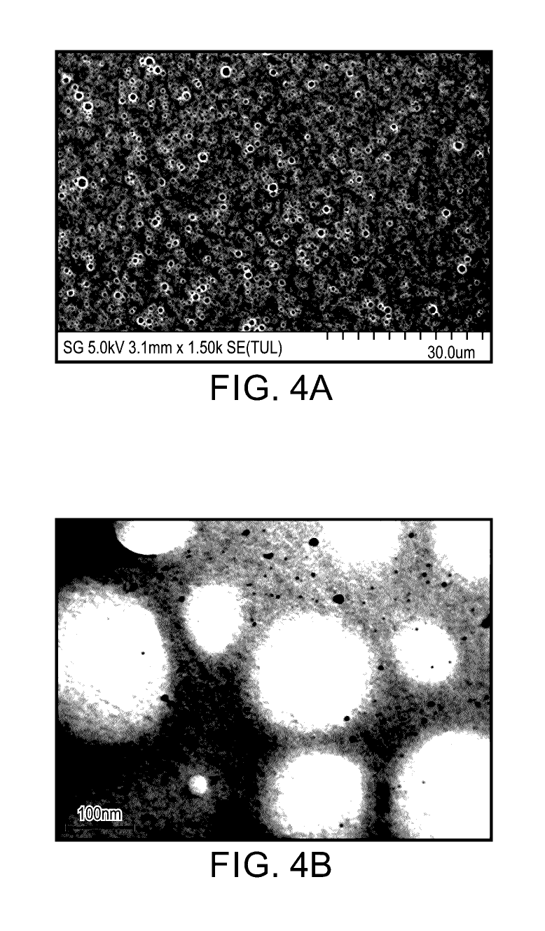

Embodiments herein provide methods of synthesizing silver nanoparticles (AgNPs) by reduction of silver (I) ion simultaneously during the self-assembly of sodio sulfonated polyester resin particles in water. The methods which employ water as the bulk solvent are environmentally friendly being free of organic solvents. The methods are efficient requiring minimal time to prepare the polymer metal nanocomposites. Without being bound by theory it is postulated that silver ions are trapped within the polymer matrix during the self-assembly of the sodio sulfonated polyester while simultaneously being reduced to AgNPs. The silver sulfonated polyester complexes are simultaneously synthesized during the self-assembly or dispersing of polymer in water as indicated in FIG. 1. Thus, the sodio sulfonated polyester serves as both a carrier for the silver ions and an organic matrix for the in situ synthesis of silver nanocomposites. The reducing agent is added during the self-assembly of sodio sulfonated polyester to reduce silver nitrate into silver nanoparticles (AgNPs) resulting in well dispersed particles. The polyester matrix plays an important role as it is postulated to inhibit the agglomeration of AgNPs. Meanwhile, the porosity of the sulfonated polyester allows the silver ions to diffuse and/or absorb throughout the polymer matrix allowing unhindered interaction with the sulfonate functional groups of the polyester. The reducing agent employed in the reduction of silver ion also freely diffuses throughout the polyester matrix and promotes the formation of well-dispersed AgNPs on the surface and interior of the polyester particles. Advantageously, the process minimizes nanoparticle agglomeration that plagues conventional methods with pre-formed nanoparticles. The sulfonated polymer matrix has an important role in keeping the AgNPs dispersed as well as maintaining overall chemical and mechanical stability of the composite.

The novel properties of the silver nanocomposite materials disclosed herein make them useful in applications such as electronics components, optical detectors, chemical and biochemical sensors and similar devices. The ability to miniaturize any of these materials is a substantial benefit of the silver nanocomposite materials described herein. Silver has many useful properties, including its antibacterial and antimicrobial properties. As such, other areas of interest where the silver nanocomposite materials would be useful include, in antibacterial and antimicrobial applications. Further areas of interest where silver nanocomposite materials would be useful include optical bi-stability, textiles, photoresponsivity, and the like.

The sulfonated polyester resins disclosed herein have been selected to have a hydrophobic backbone while presenting hydrophilic sulfonate groups attached along the chain. Without being bound by theory, when placed in water and heated, the hydrophobic portions may interact with each other to form a hydrophobic core with the hydrophilic sulfonate groups facing the surrounding water resulting in the sulfonated polyester self-assembling into a higher order, spherical nanoparticle without the requirement of additional reagents. Thus, there is a higher order involving the amphiphilic polyester, in which the hydrophobic backbone, which is insoluble in water, and the water-soluble hydrophilic sulfonate groups, operate as macrosurfactants. This results in self-association, self-assembly, self-dispersible nanoparticles in aqueous medium to yield micelle-like aggregates. The formation of silver nanoparticles within and surrounding the micelles is a secondary occurrence upon addition of silver nitrate and reducing agent.

In embodiments, there are provided composites comprising a sulfonated polyester matrix, and a plurality of silver nanoparticles dispersed within the matrix.

In embodiments, the sulfonated polyester matrix is a branched polymer. In embodiments, the sulfonated polyester matrix is a linear polymer. The selection of branched or linear polymer may depend on, inter alia, the downstream application of the composite product. Linear polymers can be used to create strands of fibers or form a strong mesh-like structure. Branched polymers may be useful to confer thermoplastic properties on the resultant composite material.

Both linear amorphous and branched amorphous sulfonated polyester resins are alkali sulfonated polyester resins. The alkali metal in the respective sulfonated polyester resins may independently be lithium, sodium, or potassium.In embodiments, the sulfonated polyester matrix is selected from the group consisting of poly(1,2-propylene-5-sulfoisophthalate), poly(neopentylene-5-sulfoisophthalate), poly(diethylene-5-sulfoisophthalate), copoly-(1,2-propylene-5-sulfoisophthalate)-copoly-(1,2-propylene-terphthalate), copoly-(1,2-propylenediethylene-5-sulfoisophthalate)-copoly-(1,2-propylene-diethylene-terephthalatephthalate), copoly(ethylene-neopentylene-5-sulfoisophthalate)-copoly-(ethylene-neopentylene-terephthalatephthalate), and copoly(propoxylated bisphenol A)-copoly-(propoxylated bisphenol A-5-sulfoisophthalate).

In general, the sulfonated polyesters may have the following general structure, or random copolymers thereof in which the n and p segments are separated.

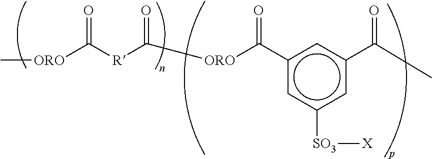

wherein R is an alkylene of, for example, from 2 to about 25 carbon atoms such as ethylene, propylene, butylene, oxyalkylene diethyleneoxide, and the like; R′ is an arylene of, for example, from about 6 to about 36 carbon atoms, such as a benzylene, bisphenylene, bis(alkyloxy) bisphenolene, and the like; and p and n represent the number of randomly repeating segments, such as for example from about 10 to about 100,000.

Examples further include those disclosed in U.S. Pat. No. 7,312,011 which is incorporated herein by reference in its entirety. Specific examples of amorphous alkali sulfonated polyester based resins include, but are not limited to, copoly(ethylene-terephthalate)-copoly-(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfo-isophthalate), copoly(propylene-butylene-terephthalate)-copoly(propylene-butylene-5-sulfo-isophthalate), copoly(propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), and wherein the alkali metal is, for example, a sodium, lithium or potassium ion. Examples of crystalline alkali sulfonated polyester based resins alkali copoly(5-sulfoisophthaloyl)-co-poly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), and alkali copoly(5-sulfo-iosphthalbyl)-copoly(octylene-adipate), alkali copoly(5-sulfo-isophthaloyl)-copoly(ethylene-adipate), alkali copoly(5-sulfo-isophthaloyl)-copoly (propylene-adipate), alkali copoly(5-sulfo-isophthaloyl)-co-poly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl-copoly(butylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-iosphthaloyl)-copoly(butylene-adipate), alkali copoly(5-sulfo-isophthaloyl)-copoly(pentylene-adipate), alkali copoly(5-sulfo-isophthaloyl)copoly(hexylene-adipate), poly(octylene-adipate), and wherein the alkali is a metal like sodium, lithium or potassium. In embodiments, the alkali metal is lithium. In embodiments, the alkali metal is sodium.

The linear amorphous polyester resins are generally prepared by the polycondensation of an organic diol and a diacid or diester, at least one of which is sulfonated or a sulfonated difunctional monomer being included in the reaction, and a polycondensation catalyst. For the branched amorphous sulfonated polyester resin, the same materials may be used, with the further inclusion of a branching agent such as a multivalent polyacid or polyol.

Examples of diacid or diesters selected for the preparation of amorphous polyesters include dicarboxylic acids or diesters selected from the group consisting of terephthalic acid, phthalic acid, isophthalic acid, fumaric acid, maleic acid, itaconic acid, succinic acid, succinic anhydride, dodecylsuccinic acid, dodecylsuccinic anhydride, glutaric acid, glutaric anhydride, adipic acid, pimelic acid, suberic acid, azelic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and mixtures thereof. The organic diacid or diester are selected, for example, from about 45 to about 52 mole percent of the resin. Examples of diols utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hyroxyethyl)-bisphenol A, bis(2-hyroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and mixtures thereof. The amount of organic diol selected can vary, and more specifically, is, for example, from about 45 to about 52 mole percent of the resin.

Alkali sulfonated difunctional monomer examples, wherein the alkali is lithium, sodium, or potassium, include dimethyl-5-sulfo-isophthalate, dialkyl-5-sulfo-isophthalate-4-sulfo-1,8-naphthalic anhydride, 4-sulfo-phthalic acid, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, dialkyl-sulfo-terephthalate, sulfo-ethanediol, 2-sulfo-propanediol, 2-sulfo-butanediol, 3-sulfo-pentanediol, 2-sulfo-hexanediol, 3-sulfo-2-methylpentanediol, N,N-bis(2-hydroxyethyl)-2-aminoethane sulfonate, 2-sulfo-3,3-dimethylpent-anediol, sulfo-p-hydroxybenzoic acid, mixtures thereto, and the like. Effective difunctional monomer amounts of, for example, from about 0.1 to about 2 weight percent of the resin can be selected.

Branching agents for use in forming the branched amorphous sulfonated polyester include, for example, a multivalent polyacid such as 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane, and 1,2,7,8-octanetetracarboxylic acid, acid anhydrides thereof, and lower alkyl esters thereof, 1 to about 6 carbon atoms; a multivalent polyol such as sorbitol, 1,2,3,6-hexanetetrol, 1,4-sorbitane, pentaerythritol, dipentaerythritol, tripentaerythritol, sucrose, 1,2,4-butanetriol, 1,2,5-pentatriol, glycerol, 2-methylpropanetriol, 2-methyl-1,2,4-butanetriol, trimethylolethane, trimethylolpropane, 1,3,5-trihydroxymethylbenzene, mixtures thereof, and the like. The branching agent amount selected is, for example, from about 0.1 to about 5 mole percent of the resin.

Polycondensation catalyst examples for amorphous polyesters include tetraalkyl titanates, dialkyltin oxide such as dibutyltin oxide, tetraalkyltin such as dibutyltin dilaurate, dialkyltin oxide hydroxide such as butyltin oxide hydroxide, aluminum alkoxides, alkyl zinc, dialkyl zinc, zinc oxide, stannous oxide, or mixtures thereof; and which catalysts are selected in amounts of, for example, from about 0.01 mole percent to about 5 mole percent based on the starting diacid or diester used to generate the polyester resin.

As used herein, references to “particle size” will generally refer to D₅₀ mass-median-diameter (MMD) or the log-normal distribution mass median diameter. The MMD is considered to be the average particle diameter by mass.

In embodiments, the composite has a particle size in a range from about 5 nm to about 500 nm or from about 10 to about 200 nm, or from about 20 to about 100 nm. A composite particle size of less than 100 nm may be useful for reinforcement of polymer matrices without disturbing transparency and other properties of coatings. Tsavalas, J. G. et al. J. Appl. Polym. Sci., 87:1825-1836 (2003).

In embodiments, a loading of silver is present in the composite is in a range from about 100 ppm to about 10,000 ppm or from about 200 ppm (0.02%) to about 5,000 ppm (0.5%), or from about 500 ppm (0.05%) to about 1,000 ppm (0.1%). Loading concentrations of silver within these ranges can be used for antibacterial applications. Lower concentrations of silver might be sufficient for catalytic applications; concentrations of AgNPs as low as 1 ppm have been used in literature. Ghosh, S. K. et al. Langmuir. 18(23):8756-8760 (2002).

In embodiments, the silver nanoparticles have a particle size in a range from about 2 nm to about 50 nm, or from about 10 nm to about 50 nm, or from about 20 nm to about 50 nm. Silver nanoparticles of diameter less than 100 nm absorb light primarily below 500 nm. This property is useful as it allows the AgNPs to be used in combination with fluorescence emission detection since most fluorophores emit at a wavelength above 500 nm, thus minimizing quenching of the signal.

In embodiments, the silver nanoparticles may comprise solely elemental silver or may be a silver composite, including composites with other metals. Such metal-silver composite may include either or both of (i) one or more other metals and (ii) one or more non-metals. Suitable other metals include for example Al, Au, Pt, Pd, Cu, Co, Cr, In, and Ni, particularly the transition metals for example Au, Pt, Pd, Cu, Cr, Ni, and mixtures thereof. Exemplary metal composites are Au—Ag, Ag—Cu, Au—Ag—Cu, and Au—Ag—Pd. Suitable non-metals in the metal composite include for example Si, C, and Ge. The various components of the silver composite may be present in an amount ranging for example from about 0.01% to about 99.9% by weight, particularly from about 10% to about 90% by weight. In embodiments, the silver composite is a metal alloy composed of silver and one, two or more other metals, with silver comprising for example at least about 20% of the nanoparticles by weight, particularly greater than about 50% of the nanoparticles by weight. Unless otherwise noted, the weight percentages recited herein for the components of the silver-containing nanoparticles do not include the stabilizer.

Silver nanoparticles composed of a silver composite can be made for example by using a mixture of (i) a silver compound (or compounds, especially silver (I) ion-containing compounds) and (ii) another metal salt (or salts) or another non-metal (or non-metals) during the reduction step.

Those skilled in the art will appreciate that metals other than silver may be useful and can be prepared in accordance with the methods disclosed herein. Thus, for example, composites may be prepared with nanoparticles of copper, gold, palladium, or composites of such exemplary metals.

In embodiments, the composites may comprise further nanostructured materials, such as, without limitation, carbon nanotubes (CNTs, including single-walled, double-walled, and multi-walled), graphene sheet, nanoribbons, nano-onions, hollow nanoshell metals, nano-wires and the like. In embodiments, CNTs may be added in amounts that enhance electrical and thermal conductivity.

In embodiments, there are provided methods comprising heating a sulfonated polyester resin in water, adding a solution of silver (I) ion to the heated resin in water to form a mixture, adding a solution of a reducing agent to the mixture, thereby forming an emulsion of composite particles comprising a sulfonated polyester matrix and a plurality of silver nanoparticles disposed within the sulfonated polyester matrix.

In embodiments, heating is conducted at a temperature from about 65° C. to about 90° C.

In embodiments, a source of silver (I) ion is selected from silver nitrate, silver sulfonate, silver fluoride, silver perchlorate, silver lactate, silver tetrafluoroborate, silver oxide, silver acetate. Silver nitrate is a common silver ion precursor for the synthesis of AgNPs.

In embodiments, the reducing agent is selected from ascorbic acid, trisodium citrate, glucose, galactose, maltose, lactose, gallic acid, rosmaric acid, caffeic acid, tannic acid, dihydrocaffeic acid, quercetin, sodium borohydride, potassium borohydride, hydrazine hydrate, sodium hypophosphite, hydroxylamine hydrochloride. In embodiments, reducing agents for the synthesis of AgNPs may include sodium borohydride or sodium citrate. Selection of appropriate reducing agent may provide access to desirable nanoparticle morphologies. For example, ascorbic acid was observed to provide silver nanoplate forms during a study directed to quantitation of vitamin C tablets. Rashid et al. J. Pharm. Sci. 12(1):29-33 (2013).

In embodiments, methods disclosed herein may be particularly well-suited for making composites with relatively low solids content. Under such conditions, silver ion and reducing agent may readily diffuse through the polymer matrix. In the case of silver ion, such ready diffusion may improve uniformity of distribution of silver throughout the matrix.

In embodiments, there are provided articles comprising a composite comprising a sulfonated polyester matrix, and a plurality of silver nanoparticles dispersed within the matrix. In embodiments, the article is selected from the group consisting of a biochemical sensor, an optical detector, an antibacterial, a textile, a cosmetic, an electronic component, a fiber, and a cryogenic superconducting material.

The composites herein can be can be used to manufacture articles such as sensors, materials with solvent switchable electronic properties, optical limiters and filters, and optical data storage. The plasmonic properties of nanosilver, in particular, also make it useful for bioimaging because, contrary to commonly used fluorescent dyes, nanoparticulate silver does not undergo photobleaching and can be used to monitor dynamic events over an extended period of time. The composites disclosed herein can also be applied to catalytic applications.

In the context of antimicrobial coatings, colloidal silver has been indicated to work as a catalyst disabling the enzyme that one-celled bacteria, fungi and viruses use for their metabolism. Many disease-causing organisms can be effectively eradicated in presence of even minute traces of silver. Indeed, colloidal silver is effective against more than 650 different disease-causing pathogens. Unlike with antibiotics, strains resistant to silver have yet to be identified.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

General Process: Composite preparation involves dispersing a branched sodio sulfonated polyester (BSPE) in water at about 90° C., followed by addition of a silver nitrate solution and lastly a mild reducing agent such as trisodium citrate or ascorbic acid is added. The reduction of Ag(I) to Ag(0) occurs after the addition of Ag(I) salt to the BSPE and is facilitated by the reducing agent. AgNP-BSPE systems that are synthesized via the trisodium citrate reductant route can also utilize the citrate cap for further applications such as biosensors where the citrate ligand is employed for analyte binding for quantitative or qualitative analysis of analyte concentration in a sample.

### Example 1

This example describes the preparation of a branched sodio sulfonated amorphous polyesters (BSPE-1).

A branched amorphous sulfonated polyester resin comprised of 0.425 mole equivalent of terephthalate, 0.080 mole equivalent of sodium 5-sulfoisophthalic acid, 0.4501 mole equivalent of 1,2-propanediol, and 0.050 mole equivalent of diethylene glycol, was prepared as follows. In a one-liter Parr reactor equipped with a heated bottom drain valve, high viscosity double turbine agitator, and distillation receiver with a cold water condenser was charged 388 grams of dimethylterephthalate, 104.6 grams of sodium 5-sulfoisophthalic acid, 322.6 grams of 1,2-propanediol (1 mole excess of glycols), 48.98 grams of diethylene glycol, (1 mole excess of glycols), trimethylolpropane (5 grams) and 0.8 grams of butyltin hydroxide oxide as the catalyst. The reactor was heated to 165° C. with stirring for 3 hours and then again heated to 190° C. over a one hour period, after which the pressure was slowly reduced from atmospheric pressure to about 260 Torr over a one hour period, and then reduced to 5 Torr over a two hour period. The pressure was then further reduced to about 1 Torr over a 30 minute period and the polymer was discharged through the bottom drain onto a container cooled with dry ice to yield 460 grams of sulfonated-polyester resin. The branched sulfonated-polyester resin had a glass transition temperature measured to be 54.5° C. (onset) and a softening point of 154° C.

### Example 2

### Control Sample

This Example describes the preparation of a control emulsion with no AgNPs.

The reaction was carried out in a 3 necked, 500 mL round bottom flask equipped with an overhead stirrer, reflux condenser, thermocouple, hot plate, and nitrogen entrance (the condenser acted as the nitrogen exit). 125 mL of deionized water was charged into flask at room temperature (22° C.). The water was heated to 90° C. with stirring while nitrogen running through the solution (RPM=330). Then 50.0 g of finely ground, solid BSPE-1 was added to the de-ionized water (RPM=400). The solution was stirred at 90° C. for 2 hours (RPM=400). Then the BSPE emulsion was cooled to room temperature with stirring (RPM=400). The final appearance was a white, opaque solution.

### Example 3

This Example shows the preparation of Sample 1 which employs trisodium citrate as the reducing agent.

The reaction was carried out in a 3 necked, 500 mL round bottom flask equipped with an overhead stirrer, reflux condenser, thermocouple, hot plate, and nitrogen entrance (the condenser acted as the nitrogen exit). 248 mL of de-ionized water was charged into the flask at room temperature (22° C.). The heat was turned on set to 90° C. and nitrogen was run through the system (RPM=300). Once the temperature had stabilized, 0.8490 g of solid BSPE-1 was added to the system in a finely ground state (RPM=300). The solution became hazy and had a blue tinge. After 1.5 hrs., 0.0849 g AgNO₃ dissolved in 2 mL of de-ionized water was added dropwise to the solution at a rate of approx. 1 drop/second (RPM=300). The solution became slightly darker (brownish). After 10 minutes, 5 mL of 1% (w/w%) trisodium citrate solution (reducing agent) was added to the system dropwise at a rate of 1 drop/second. Upon complete addition, the solution was stirred at 90° C. for 2 hours (RPM=300). The solution was allowed to cool to room temperature (RPM=300). The final appearance was a peach coloured, slightly hazy solution.

### Example 4

This Example shows the preparation of Sample 2 which employs trisodium citrate as the reducing agent.

The reaction was carried out in a 3 necked, 500 mL round bottom flask equipped with an overhead stirrer, reflux condenser, thermocouple, hot plate, and nitrogen entrance (the condenser acted as the nitrogen exit). 108 mL of de-ionized water was charged into the flask at room temperature (22° C.). The heat was turned on set to 90° C. and nitrogen was run through the system (RPM=300). Once the temperature had stabilized, 25.00 g of solid BSPE-1 was added to the system in a finely ground state (RPM=300). The solution became hazy and had a blue tinge. After 1.5 hrs., 0.2500 g AgNO₃ dissolved in 2 mL of de-ionized water was added dropwise to the solution at a rate of approx. 1 drop/second (RPM=300). The solution became slightly darker (brownish). After 25 minutes, 15 mL of 1% (w/w%) trisodium citrate solution (reducing agent) was added to the system dropwise at a rate of 1 drop/second. Upon complete addition, the solution was stirred at 90° C. for 2 hours (RPM=300). The solution was allowed to cool to room temperature (RPM=300). The final appearance was a peach coloured, slightly hazy solution.

### Example 5

This Example shows the preparation of Sample 3 which employs trisodium citrate as the reducing agent.

The reaction was carried out in a 3 necked, 500 mL round bottom flask equipped with an overhead stirrer, reflux condenser, thermocouple, hot plate, and nitrogen entrance (the condenser acted as the nitrogen exit). 96.75 mL of de-ionized water was charged into the flask at room temperature (22° C.). The heat was turned, set to 90° C. and nitrogen was run through the system (RPM=300). Once the temperature had stabilized, 50.00 g of solid BSPE-1 was added to the system in a finely ground state (RPM=300). The solution became hazy and had a blue tinge. After 1.5 hrs., 0.5000 g AgNO₃ dissolved in 2 mL of de-ionized water was added dropwise to the solution at a rate of approx. 1 drop/second (RPM=300). The solution became slightly darker (brownish). After 45 minutes, 26.25 mL of 1% (w/w%) trisodium citrate solution (reducing agent) was added to the system dropwise at a rate of 1 drop/second. Upon complete addition, the solution was stirred at 90° C. for 2 hours (RPM=300). The solution was allowed to cool to room temperature (RPM=300). The final appearance was a peach coloured, slightly hazy solution.

### Example 6

This Example shows the preparation of Sample 4 which employs L-ascorbic acid as the reducing agent.

The reaction was carried out in a 3 necked, 500 mL round bottom flask equipped with an overhead stirrer, reflux condenser, thermocouple, hot plate, and nitrogen entrance (the condenser acted as the nitrogen exit). 150 mL of de-ionized water and 0.3000 g AgNO₃ were charged into the flask at room temperature (22° C.). The heat was turned on set to 90° C. and nitrogen was run through the system for 0.5 hrs. (RPM=550). Once the temperature had stabilized, the 30.00 g BSPE-1 was added to the system in a finely ground state (RPM=550). The solution became a dark green/brown colour. Let stir for 1.25 hrs (RPM=400). Began the dropwise addition of 150 mL of 0.06M L-Ascorbic acid solution (reducing agent) over 1.5 hours (RPM=530). Solution became browner as reducing agent was added. Let stir for 2.25 hrs. longer at 90° C. (RPM=530). Let cool to room temperature. The final appearance was a brown, opaque solution.

### Example 7

This Example shows the preparation of Samples 5, 6, and 7 which employ trisodium citrate as the reducing agent.

The reaction was carried out in a 3 necked, 500 mL round bottom flask equipped with an overhead stirrer, reflux condenser, thermocouple, hot plate, and nitrogen entrance (the condenser acted as the nitrogen exit). 248 mL of de-ionized water was charged into the flask at room temperature (22° C.). The heat was turned on set to 90° C. and nitrogen was run through the system (RPM=300). Once the temperature had stabilized, 21.61 g of solid BSPE-1 was added to the system in a finely ground state (RPM=300). The solution became hazy and had a pale blue tinge. After 0.5 hrs., AgNO₃ dissolved in 2 mL de-ionized water (0.0849 g, 0.0550 g or 0.1184 g AgNO₃ for Sample 5, 6 and 7, respectively) was added dropwise to the solution at a rate of approx. 1 drop/second (RPM=300). The solution became green/brown. After 0.5 hrs, 5 mL of 1% (w/w %) trisodium citrate solution (reducing agent) was added to the system dropwise at a rate of 1 drop/second. Upon complete addition, the solution was stirred at 90° C. for 2 hours (RPM=300). The solution was allowed to cool to room temperature (RPM=300). The final appearance was a brown, opaque solution. Table 1 shows characterization of particles for BSPE-AgNP samples.

TABLE 1

| | Loading | | | Loading | Loading | Actual | Particle | Zeta |
|---|---|---|---|---|---|---|---|---|
| Sample | conc. Of | Reducing | Theoretical | [AgNO₃] | [AgNO₃] | % | Size-D₅₀ | Potential |
| Name | Ag+ (M) | Agent Used | % Solids | (M) | (w/w %) | Solids | (nm) | (mV) |
| Control | 0 | None | 28.57% | 0.0000 | 0.00% | 29.46% | 31.8 | −58.9 |
| 1 | 1.96E−03 | Trisodium | 0.38% | 0.0020 | 0.03% | 0.38% | 25.7 | −46.7 |
| | | citrate | | | | | | |
| 2 | 1.05E−02 | Trisodium | 16.89% | 0.0105 | 0.15% | 16.35% | 33.9 | −56.9 |
| | | citrate | | | | | | |
| 3 | 2.35E−02 | Trisodium | 28.88% | 0.0232 | 0.28% | 25.47% | 51.9 | −61.5 |
| | | citrate | | | | | | |
| 4 | 5.89E−03 | L−Ascorbic | 9.61% | 0.0059 | 0.09% | 9.39% | 30.4 | −74.6 |
| | | acid | | | | | | |
| 5 | 1.96E−03 | Trisodium | 7.86% | 0.0020 | 0.03% | 8.05% | 23.2 | −56.0 |
| 6 | 1.27E−03 | citrate | 7.85% | 0.0013 | 0.02% | 7.95% | 27.5 | −54.3 |
| 7 | 2.73E−03 | | 7.87% | 0.0027 | 0.04% | 7.58% | 25.4 | −55.8 |

TABLE 2

| | Loading | | | | | | | | TGA- | | ICP- |
|---|---|---|---|---|---|---|---|---|---|---|---|
| Sample | [AgNO₃] | | | | | Onset | Midpoint | Offset | Residue | Ash | Ag |
| Name | (w/w %) | Mw | Mn | Mp | PD | Tg (° C.) | Tg (° C.) | Tg (° C.) | (% wt. loss) | (%) | (ppm) |
| Control | 0.000% | 4226 | 1759 | 5388 | 2.403 | 55.09 | 59.31 | 63.52 | 2.206 | n/a | None- |
| | | | | | | | | | | | control |
| 1 | 0.030% | 12907 | 4462 | 24236 | 2.893 | 55.04 | 60.01 | 64.98 | 8.275 | 9.76 | 10210 |
| 2 | 0.150% | 8021 | 2903 | 19018 | 2.763 | 54.94 | 58.90 | 62.86 | 3.308 | 3.43 | 5099 |
| 3 | 0.280% | 3605 | 1518 | 4536 | 2.375 | 49.53 | 53.39 | 57.26 | 3.809 | 2.49 | 448.9 |
| 4 | 0.090% | 5479 | 1748 | 5169 | 3.135 | 45.00 | 49.91 | 54.82 | 3.791 | 3.17 | 5381 |
| 5 | 0.030% | 3903 | 1661 | 4883 | 2.350 | 55.03 | 59.13 | 63.23 | 3.079 | 2.53 | 688.6 |
| 6 | 0.020% | 3526 | 1516 | 4247 | 2.327 | 55.00 | 59.07 | 63.14 | 2.957 | 2.84 | 348.4 |
| 7 | 0.050% | 3500 | 1498 | 4447 | 2.336 | 55.79 | 59.66 | 63.53 | 2.841 | 2.80 | 1089 |

Table 2. BSPE-AgNP composite properties (GPC, DSC, TGA, Ash, ICP for Ag). Table 2 above indicates that Sample 1 is greatly influenced by the high degree of AgNP dispersibility in the polymer matrix compared to other samples. The well dispersed AgNPs within the BSPE matrix will provide enhanced mechanical properties and thermal stability. The glass transition temperature has not changed when compared to the control sample but the degree of polymerization increased dramatically as seen from molecular weight. Overall, BSPE is found to be an effective support for the stabilization of AgNPs when reduced in situ. Inorganic-polymer hybrid materials in general are desirable in many applications due to the very unique characteristics that these materials exhibit.

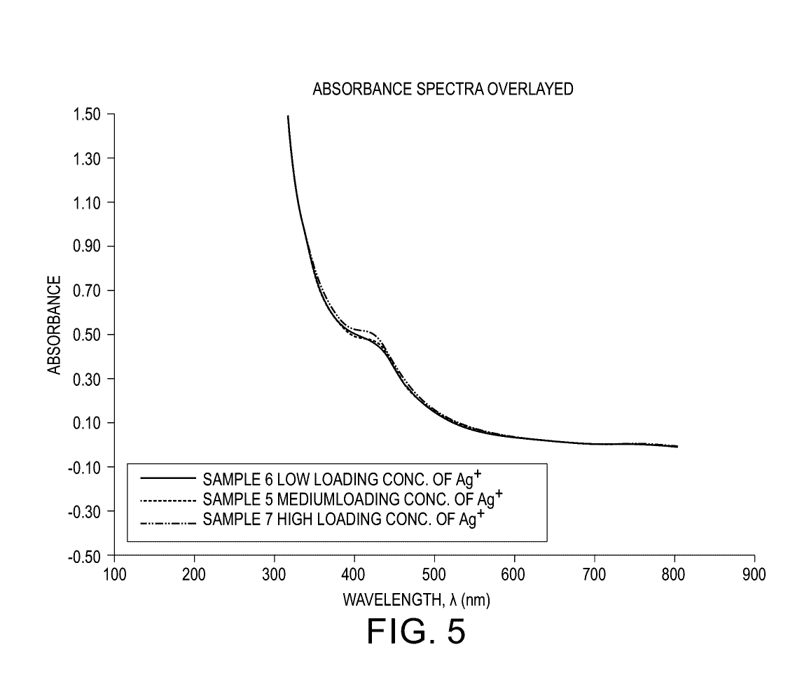

AgNPs display surface plasmon resonance (SPR) upon irradiation with light resulting in SPR peaks in the UV-VIS wavelength range. The SPR phenomenon is a result of the interactions between the incident light and the free electrons in the conduction band of the AgNPs. Luoma, S. N. Project on Emerging Nanotechnologies, The Pew Charitable Trusts (2008); Tolaymat, T., et al. Sci. Tot. Environ., (408)5:999-1006 (2010). FIG. 5 shows the UV-Vis absorption spectra of three AgNP-BSPE dispersions. Small increases in λₘₐₓ are seen with increasing Ag⁺ in the BSPE matrix. The absorption of these particles falls between 420 to 430 nm indicating that all samples have very similar particle size as confirmed by Nanotrac measurements reported in Table 1. The surface plasmon resonance (i.e., plasmon band width and peak position) is affected by the size, shape and surface properties of the silver nanoparticles. Ju-Nam, Y., et al. Sci. Tot. Environ., 400:396-4143 (2008).

What is claimed is:

1. A method of producing a composite matrix, comprising:
dispersing a sulfonated polyester resin in water and heating the water to produce a heated aqueous dispersion of sulfonated polyester resin;
adding to the heated aqueous dispersion of sulfonated polyester resin a solution of silver ions to produce a mixture; and
forming from the sulfonated polyester resin a porous matrix while adding to the mixture an effective amount of a reducing agent for synthesizing, in situ, a plurality of silver nanoparticles from the solution of silver ions, whereby the plurality of silver nanoparticles are dispersed throughout pores of the porous matrix to produce a composite matrix comprising silver nanoparticles and sulfonated polyester resin.

2. The method of claim 1, wherein heating is conducted at a temperature of from 65° C. to about 90° C.

3. A composite matrix produced by a method that comprises:
dispersing a sulfonated polyester resin in water and heating the water to produce a heated aqueous dispersion of sulfonated polyester resin;
adding to the heated aqueous dispersion of sulfonated polyester resin a solution of silver ions to produce a mixture; and
forming from the sulfonated polyester resin a porous matrix while adding to the mixture an effective amount of a reducing agent for synthesizing, in situ, a plurality of silver nanoparticles from the solution of silver ions, whereby the plurality of silver nanoparticles are dispersed throughout pores of the porous matrix to produce a composite matrix comprising silver nanoparticles and sulfonated polyester resin.

4. The composite matrix of claim 3, wherein the composite matrix has a particle size of from about 5 nm to about 500 nm.

5. The composite matrix of claim 3, wherein the composite matrix has a silver loading of from about 100 ppm to about 10,000 ppm.

6. The composite matrix of claim 3, wherein the silver nanoparticles have a particle size of from about 2 nm to about 50 nm.

7. The composite matrix of claim 3, wherein the silver nanoparticles are a composite with one or more other metals.

8. The composite matrix of claim 7, wherein the one or more other metals is selected from the group consisting of Al, Au, Pt, Pd, Cu, Co, Cr, In, and Ni.

9. The composite matrix of claim 3, wherein the silver nanoparticles are a composite with one or more other non-metals.

10. The composite matrix of claim 3, wherein the one or more other non-metals is selected from the group consisting of Si, C, and Ge.
